(19) United States
(12) Patent Application Publication
(10) Pub. No.: US 2002/0196346 A1
(43) Pub. Date: Dec. 26, 2002

(54) Image processing apparatus

(76) Inventors: Satoru Nishio, Nagano-ken (JP); Masanori Saito, Nagano-ken (JP)

Correspondence Address: MARTINE & PENILLA, LLP, 710 LAKEWAY DRIVE, SUITE 170, SUNNYVALE, CA, 94085, US

(21) Appl. No.: 10/098,733

(22) Filed: Mar. 14, 2002

(30) Foreign Application Priority Data
Mar. 15, 2001 (JP) 2001-74613(P)

(51) Int. Cl. H04N 5/225

(52) U.S. Cl. 348/207.2; 348/222.1

(57) ABSTRACT

CPU 150, for image data GD for output to a color printer 20, performs image processing accompanied by color space conversion in consideration of color space information included in image processing control information GC, to a color space wRGB having a wider definition range wider than the sRGB color space. On the other hand, CPU 150, for image data GD for output to a monitor 14, performs image processing regardless of the color space information included in image processing control information GC, preserving the color space of the image data GD as the sRGB color space.

### FIELD OF THE INVENTION

The present invention relates to an image processing apparatus and image processing method using image files.

### BACKGROUND OF THE INVENTION

In devices that handle digital data such as personal computers, displays, printers and the like, the sRGB color space is used as the standard color space as the color space for representing image data. The sRGB color space is a color space that considers the output characteristics of CRT displays. Therefore, even if image data generated in an input apparatus such as a digital still camera (DSC) is defined by a color space that is wider than the sRGB color space, as long as the output apparatus uses a color space based on the sRGB color space, the colors of the image data will not be reproduced correctly.

With regard to this problem there are proposed techniques for outputting (reproducing) image data having passed through a color conversion process to a wide RGB color space having a wider definition range than the sRGB color space, besides the sRGB color space. According to the techniques in question, colors in image data generated by an input apparatus can be correctly reproduced in an output apparatus.

Typically, with image processing by means of desired adjustments by a user, image processing is performed while confirming the result of image processing displayed on a displaying display such as a CRT display. Even where image processing is executed automatically by an application or printer driver, prior to printing, the image processing result is preview displayed, and then the printing process is executed. However, since the printing apparatus and the display apparatus have a different color space ranges that can be output respectively, even for the same given image data, the image processing results displayed on the displaying display and the image printed by printing may appear different.

Accordingly, even supposing that image processing via a color conversion process to a wide RGB color space having a wider definition range than the sRGB color space were possible, insofar as the output result in the display apparatus and the output result in the printing apparatus are different, there is the problem that the color conversion process to the wide RGB color space cannot be taken advantage of. For example, in the event that a user performs image processing as desired, there is the problem that unless differences in output result in the display apparatus and output result in the printing apparatus are acquired through experience, it is not possible to perform a desired image processing. Also, even where image processing is performed automatically, there is the problem that differences in output result in the display apparatus and output result in the printing apparatus may give an unpleasant sensation to the user.

### SUMMARY OF THE INVENTION

The present invention was made in order to solve the above-mentioned problems, and has as an object to reduce differences between output result in a display apparatus and output result in a printing apparatus.

To solve the above-mentioned problems a first aspect of the present invention provides an image processing apparatus for performing image processing of image data. The image processing apparatus pertaining to the first aspect of the present invention is characterized by comprising: print image data generating means for executing image processing of image data using image processing control information that is associated with the image data and that controls image processing of the image data, to generate image data for printing; and display image data generating means for image processing the image data with consideration of the color reproduction characteristics of the display apparatus, which differ from those of the output apparatus that outputs the print image data, to generate image data for display.

According to the image processing apparatus pertaining to the first aspect of the present invention, there are provided print image data generating means for generating image data for printing, and display image data generating means for generating image data for display, so that it is possible to reduce differences between output result in a display apparatus and output result in a printing apparatus.

In the image processing apparatus pertaining to the first aspect of the present invention, the image processing control information may include color space information that is information relating to color space at the time of generating image data, with image processing performed by the print image data generating means involving reflecting the color space information, and converting the color space of the image data from a first color space to a second color space including within the definition range thereof image data at the time of image data generation and having a definition range wider than that of the first color space, and with image processing performed by the display image data generating means involving image processing in consideration of the image processing information, and color conversion, regardless of the color space information, of the color space of the image data from the first color space to a third color space reproducible by the display apparatus. Where this arrangement is provided, for print image data, definition is possible with a second color space capable of representing image data at the time of image data generation; and for display image data, definition is possible with a third color space reproducible by the display apparatus. Therefore, for both print image data and display image data, brighter output is possible.

In the image processing apparatus pertaining to the first aspect of the present invention, the image processing control information may include color space information that is information relating to the color space to be used at the time of image data processing, with image processing performed by the print image data generating means involving reflecting the color space information and converting the color space of the image data from a first color space to a second color space including within the definition range thereof image data at the time of image data generation and having a definition range wider than that of the first color space, and with image processing performed by the display image data generating means involving image processing in consideration of the image processing control information, and color space conversion, regardless of the color space information, of the color space of the image data from the first color space to a third color space reproducible by the display apparatus. Where this arrangement is provided, for print image data, image processing can be performed with a second color space reproducible by a printing apparatus having a wider reproduction range than the display apparatus, at least in some ranges, and for display image data, image processing can be performed with a third color space reproducible by the display apparatus. Therefore, for both print image data and display image data, brighter output is possible.

In the image processing apparatus pertaining to the first aspect of the present invention, the third color space may be the sRGB color space, and the second color space a wRGB color space having a definition range wider than the sRGB color space, with the display image data generating means, in the event that the first color space is the sRGB color space, performing color space conversion from the first color space to the third color space. Where image data targeted for image processing is originally image data based on the sRGB color space, the image data is based on a color space suitable as display image data, and by not performing the color space conversion process the time required for image processing can be reduced.

In the image processing apparatus pertaining to the first aspect of the present invention, the print image data generating means, in the event the image processing control information cannot be used, may perform image processing while preserving the color space of the image data in the first color space, and generate the image data for printing; and the display image data generating means, in the event that it is determined that the image processing control information is not contained in the image file, can perform image processing while preserving the color space of the image data in the first color space, to generate the image data for display. In the event that image processing control information is not contained in an image file, it is uncertain to which color space the color space of image data should be converted, but where the arrangement is provided, incorrect color space conversion processes can be prevented, and image processing can be performed omitting the color space conversion process.

In the image processing apparatus pertaining to the first aspect of the present invention, the first color space may be the sRGB color space. Further, the image processing apparatus pertaining to the first aspect of the present invention may further comprise print image data transmitting means for transmitting the generated image data for printing to a printing apparatus, and display image data transmitting means for transmitting the generated image data for display to the display apparatus. In this case image data can be sent from the image processing apparatus to a display apparatus and a printing apparatus.

A second aspect of the present invention provides an image processing method for image data. The image processing method pertaining to the second aspect of the present invention is characterized in that image processing is performed on the image data using image processing control information that is associated with the image data and that controls image processing of the image data to generate image data for printing, image processing is performed on the image data with consideration of the image processing control information and color reproduction characteristics of the display apparatus to generate image data for display, the generated image data for printing is transmitted to a printing apparatus, and the generated image data for display is transmitted to a display apparatus.

According to the image processing method pertaining to the second aspect of the present invention, working effects similar to the image processing apparatus pertaining to the first aspect of the invention may be achieved. Also, the image processing method pertaining to the second aspect of the present invention, like the image processing apparatus pertaining to the first aspect of the invention, be realized in various modes.

A third aspect of the present invention provides an image processing program for performing image processing on image data. The image processing program pertaining to the third aspect of the present invention is characterized in that a function for performing image processing on the image data using image processing control information that is associated with the image data and that controls image processing of the image data to generate image data for printing, and performing image processing on the image data with consideration of the image processing control information and color reproduction characteristics of the display apparatus to generate image data for display, a function for transmitting the generated image data for printing to a printing apparatus, a function for transmitting the generated image data for display to a display apparatus are realized by a computer.

According to the image processing program pertaining to the third aspect of the present invention, working effects similar to the image processing apparatus pertaining to the first aspect of the invention may be achieved. Also, the image processing program pertaining to the third aspect of the present invention, like the image processing apparatus pertaining to the first aspect of the invention, be realized in various modes.

### BRIEF DESCRIPTION OF THE DRAWINGS

FIG. 1 is an illustrative diagram showing an exemplary image data processing system permitting implementation of the image processing apparatus device in accordance with this embodiment.

FIG. 2 is a block diagram showing a simplified arrangement of a digital still camera capable of generating an image file (image data) for processing by the image processing apparatus device in accordance with this embodiment.

FIG. 3 is an illustrative diagram showing conceptually an internal structure for an image file stored in Exif file format useable in this embodiment.

FIG. 4 is a block diagram showing the general arrangement of a color printer 20 in accordance with this embodiment.

FIG. 5 is an illustrative diagram showing the internal arrangement of a control circuit 30 of a color printer 20 in accordance with this embodiment.

FIG. 6 is a flow chart showing a processing routine for image processing in a personal computer PC in accordance with this embodiment.

FIG. 7 is a flow chart showing a processing routine for image processing for printing based on image processing control information in a personal computer PC.

FIG. 8 is a flow chart showing a processing routine for image processing for display based on image processing control information in a personal computer PC.

FIG. 9 is a flow chart showing a processing routine for image processing for normal printing in a personal computer PC.

### DETAILED DESCRIPTION OF THE PREFERRED EMBODIMENTS

The image processing apparatus pertaining to the present invention is described hereinbelow based on examples in the order hereinbelow while referring to the drawings.

A. Arrangement of Image Processing System

B. Arrangement of Image File

C. Arrangement of Image Output Device

D. Image Processing in Personal Computer PC

E. Other Embodiments

A. Arrangement of Image Processing System

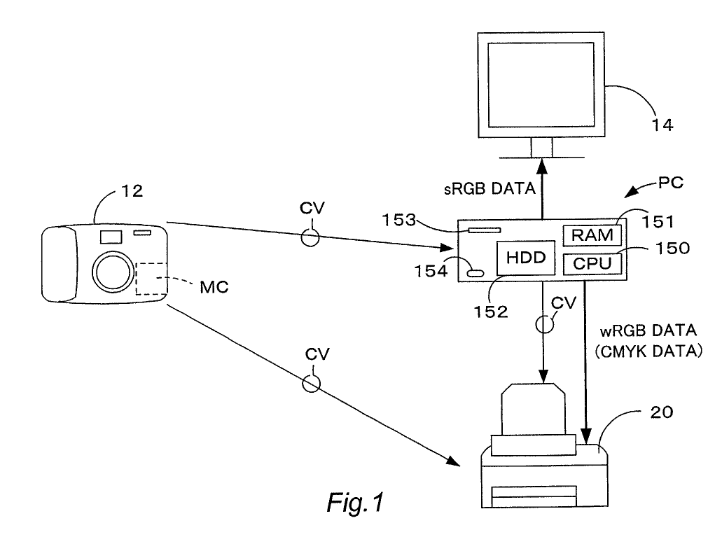

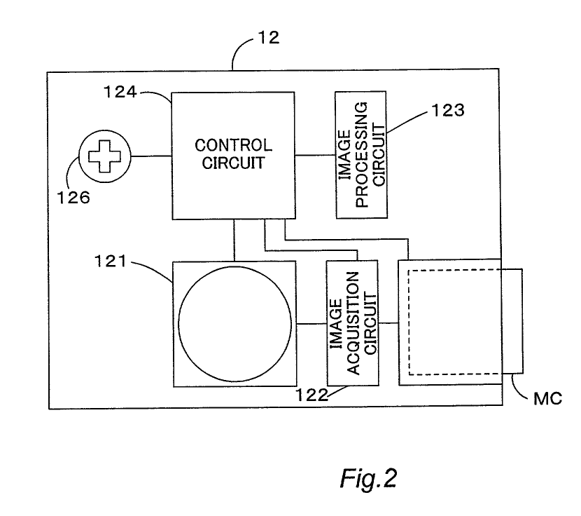

The arrangement of an image data processing system permitting implementation of the image processing apparatus device in accordance with this embodiment is described image with reference to FIGS. 1 and 2. FIG. 1 is an illustrative diagram showing an exemplary image data processing system permitting implementation of the image processing apparatus device in accordance with this embodiment. FIG. 2 is a block diagram showing a simplified arrangement of a digital still camera capable of generating an image file (image data) for processing by the image processing apparatus device in accordance with this embodiment.

Image processing system 10 comprises a digital still camera 12 as an input device for generating an image file; a personal computer PC as an image processing apparatus for performing image processing on the basis of an image file generated by digital still camera 12, and outputting image data for printing; and a color printer 20 as an output device for outputting image data for printing. As the image processing apparatus, for example, a standalone type printer may be used instead of a personal computer PC. As output apparatuses there may also be used a CRT display, LCD display, or other such monitor 124, a projector, or the like. In the description hereinbelow it shall be assumed that a color printer connected to a personal computer PC is used as the output apparatus.

Personal computer PC is a computer of a type commonly used, and comprises a CPU 150 for executing the image processing program in accordance with the present invention, RAM 151 for temporarily storing results of operations in CPU 150, image data, and the like, and a hard disk drive (HDD) 152 for storing the image processing program. Personal computer PC comprises an input terminal 154 for connection of a digital still camera 12, a connector cable from a card slot 153 for insertion of a memory card MC, or the like.

Digital still camera 12 is a camera that acquires an image by means of imaging light information with a digital device (e.g. a CCD or photomultiplier); as shown in FIG. 2 it comprises an optical circuit 121 equipped with a CCD, etc. for gathering light information, an image acquisition circuit 122 for controlling optical circuit 121 to acquire an image, an image processing circuit 123 for processing the acquired digital image; and a control circuit 124 for controlling the various circuits, and equipped with memory. Digital still camera 12 stores the acquired image as digital data in a memory card MC as the storage apparatus. As the format for storing image data in digital still camera 12, the JPEG format is typical, but other storage formats can be used such as TIFF format, GIF format, BMP format, RAW format or the like.

Digital still camera 12 also comprises a Select/Set button 126 for setting brightness, contrast, exposure compensation (exposure compensation value), white balance, and other individual image processing control parameters, and picture modes having preset a plurality of image processing control parameter values for photographic conditions, and a liquid crystal display 127 for previewing photographed images, or setting the picture mode etc., using the Select/Set button 126.

The digital still camera 12 used in this image processing system 10 stores as image file GF in a memory card MC image data GD plus image processing control information GC for image data. That is to say, image processing control information GC is automatically stored in memory card MC as information automatically making up image file GF together with image data GD at the time of shooting.

Image file GF generated by digital still camera 12 is, for example, sent to color printer 20 via a cable CV and a computer PC, or via cable CV. Or, the memory card MC on which the image file GF is stored in digital still camera 12 is connected, directly to color printer 20 or via a computer PC equipped with a memory card slot, in order to send the image file to color printer 20. In the description hereinbelow, the description is based on the case of the memory card MC being connected, directly to color printer 20.

B. Arrangement of Image File

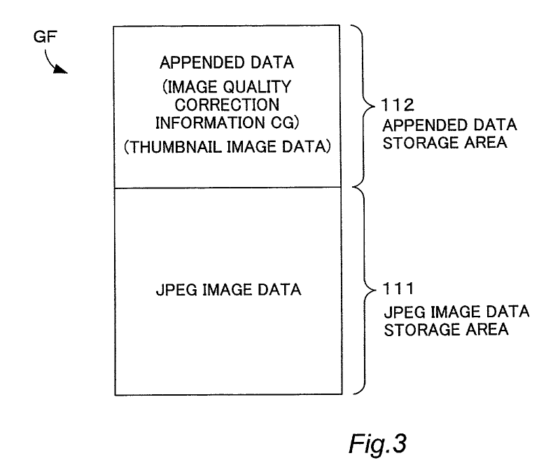

The general arrangement of an image file useable in this example is explained with reference to FIG. 3. FIG. 3 is an illustrative diagram showing conceptually an example of an internal structure for an image file useable in this example. The image file GF pertaining to this example may have, for example, a file structure according to the digital still camera image file format standard (Exif). Exif file specifications are laid down by the Japan Electronics and Information Technologies Industries Association (JEITA).

Image file GF as an Exif file comprises a JPEG image data storage area 111 for storing image data in JPEG format, and an appended information storage area 112 for storing appended information of various kinds relating to stored JPEG image data. Appended information storage area 112 contains image processing control information GC, namely date & time stamp, exposure, shutter speed, white balance, exposure compensation, target color space, etc., referred to when outputting a JPEG image. The appended information storage area 112 also contains in addition to image processing control information GC thumbnail image data in TIFF format for JPEG images stored in JPEG image data storage area 111. It is common knowledge to practitioners of the art that with files of Exif format, tags are used to identify data of various kinds, and on occasion data is referred to by its tag name. The terms file structure, data structure and storage area in this example mean a file or data image in a state wherein a file or data etc. is stored in a storage apparatus.

Image processing control information GC is information relating to picture quality at the time of generating image data (time of shooting) in a digital still camera 12 or other such image data generating apparatus, and can include image processing parameters that can be set automatically with shooting or arbitrarily by the user, such as exposure time, ISO sensitivity, aperture, shutter speed, and focal distance, and exposure compensation, white balance, picture mode, color space at the time of image processing, color space used at the time of shooting, etc., arbitrarily set by the user.

The aforementioned image processing control information GC pertaining to this example can be generated by a digital still camera 12, or by a digital video camera, scanner or other input apparatus (image file generating apparatus).

C. Arrangement of Image Output Device

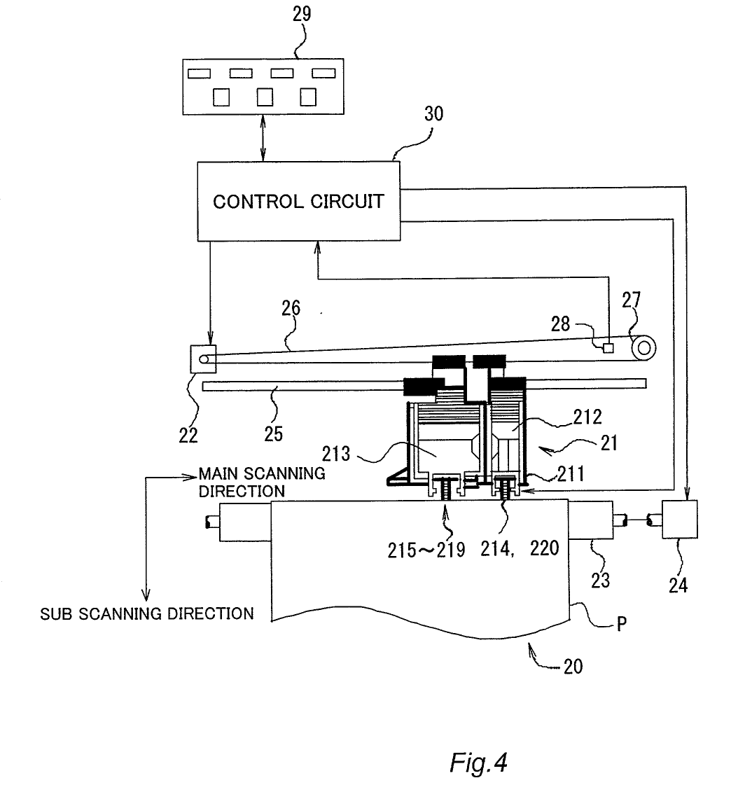

The general arrangement of an image output apparatus implementable in this example, that is, a color printer 20, is described with reference to FIG. 4. FIG. 4 is a block diagram showing the general arrangement of a color printer 20 pertaining to this example.

Color printer 20 is a printer capable of color image output and is a printer of ink-jet type that forms an image by ejecting inks of the four colors of, for example, cyan (C), magenta (M), yellow (Y) and black (K), onto a print medium to produce a dot pattern. Or it is a printer of electrophotographic type that transfer/fixes color toner onto a print medium to produce an image. For the colored inks, besides the aforementioned four colors, light cyan (LC), light magenta (LM), or dark yellow (DY)colored inks may also be used.

As shown in the drawing, color printer 20 comprises a mechanism for driving a print head 211 conveyed on a carriage 21 to perform ink ejection and dot formation, a mechanism for causing reciprocating motion of this carriage 21 in the axial direction of a platen 23 by means of a carriage motor 22, a mechanism for advancing the printer paper P by means of a paper feed motor 24, and a control circuit 30. The mechanism for causing reciprocal motion of carriage 21 in the axial direction of platen 23 comprises a slide rail 25 extending parallel to the axis of platen 23 for slidably retaining cartridge 21, a pulley 27 having an endless drive belt 26 extending between it and carriage motor 22, a position sensor 28 for sensing the home position of carriage 21, and the like. The mechanism for advancing printer paper P comprises a platen 23, a paper feed motor 24 for causing platen 23 to rotate, an auxiliary paper feed roller (not shown), and a gear train (not shown) for transmitting rotation of paper feed motor 24 to platen 23 and the auxiliary paper feed roller.

Control circuit 30, while exchanging signals with the control panel 29 of the printer, appropriately controls operation of paper feed motor 24, carriage motor 22, and print head 211. Printer paper P supplied to color printer 20 is set so as to be pinched between platen 23 and the auxiliary paper feed roller, and is advanced by predetermined increments depending on the angle of rotation of platen 23.

A ink cartridge 212 and ink cartridge 213 are installed on carriage 21. Ink cartridge 212 contains black (K) ink, while ink cartridge 213 contains other inks, specifically, inks of the three colors of cyan (C), magenta (M), yellow (Y), plus light cyan (LC), light magenta (LM), and dark yellow (DY), for a total of six colored inks.

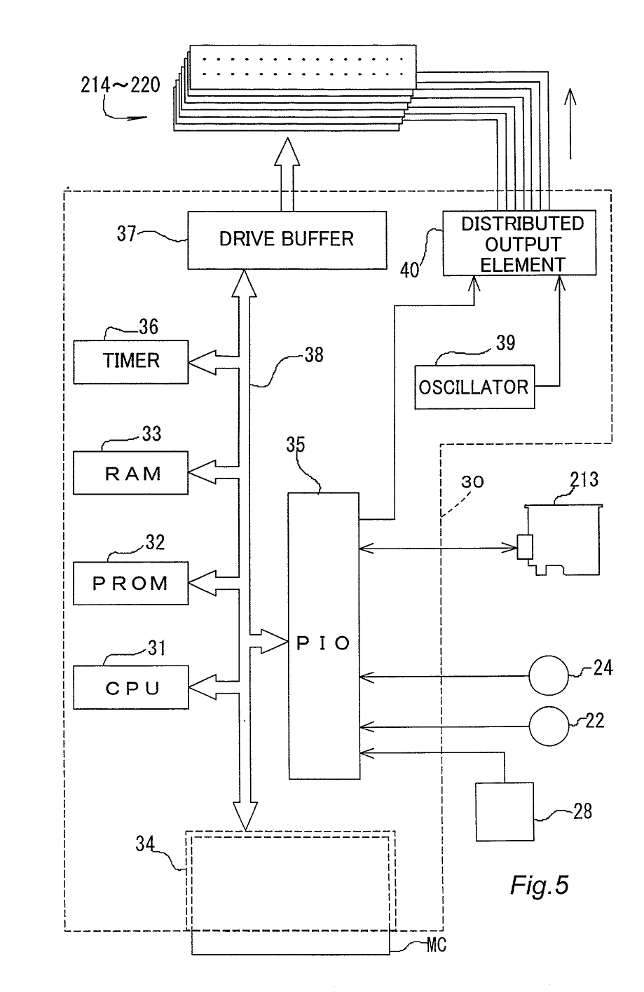

The internal arrangement of control circuit 30 of color printer 20 is described with reference to FIG. 5. FIG. 5 is an illustrative diagram showing the internal arrangement of a control circuit 30 of a color printer 20 pertaining to this example. As shown in the drawing, control circuit 30 comprises a CPU 31; PROM 32; RAM 33; a PCMCIA slot 34 for acquiring data from a memory card MC; a peripheral I/O portion (PIO) 35 for performing exchange of data with paper feed motor 24, carriage motor 22 etc., a timer 36, a drive buffer 37 and the like. Drive buffer 37 is used as a buffer for supplying dot ON/OFF signals to ink ejecting heads 214-220. These are interconnected by means of a bus 38 to enable exchange of data among them. Control circuit 30 additionally comprises an oscillator 39 for outputting a drive waveform of predetermined frequency, and a distributed output element 40 for distributing output from oscillator 39 to ink ejecting heads 214-220 at predetermined timing.

Control circuit 30 reads out an image file GF from memory card MC and transmits the image file GF to the personal computer PC. Control circuit 30, in order to output image data for printing image processed in personal computer PC on the basis of image processing control information GC, outputs dot data to drive buffer 37 at predetermined timing while synchronizing with operation of paper feed motor 24 and carriage motor 22.

D. Image Processing in Personal Computer PC

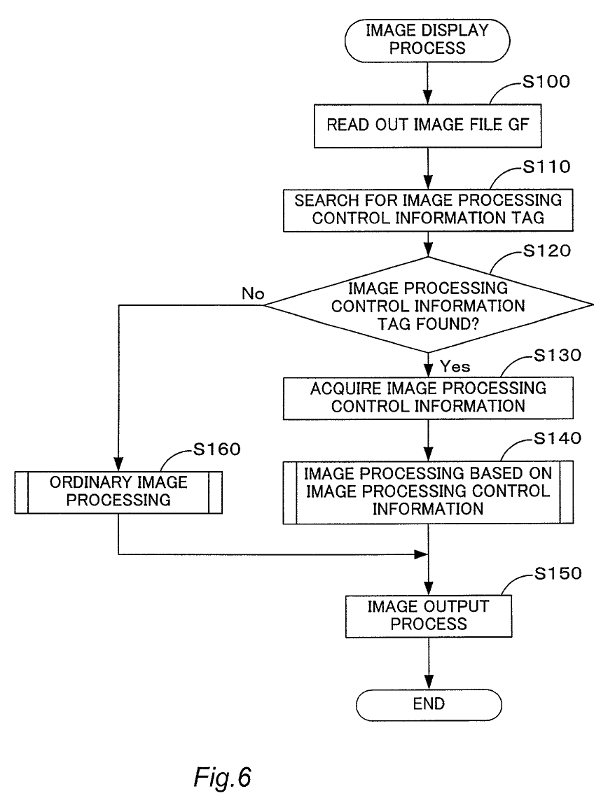

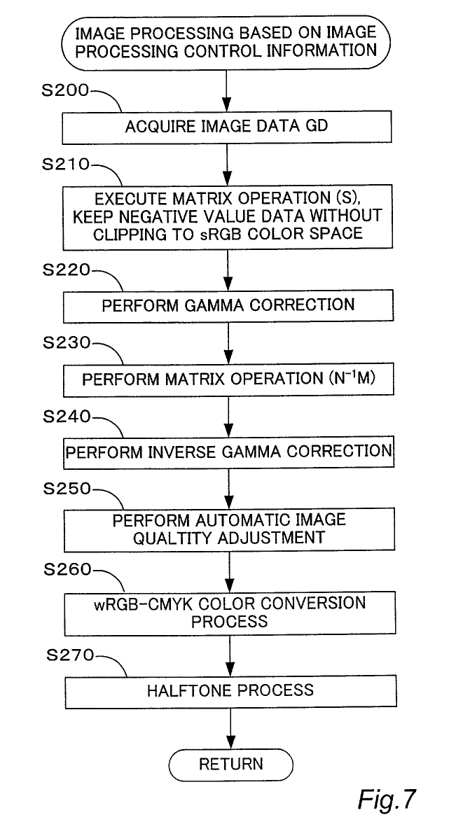

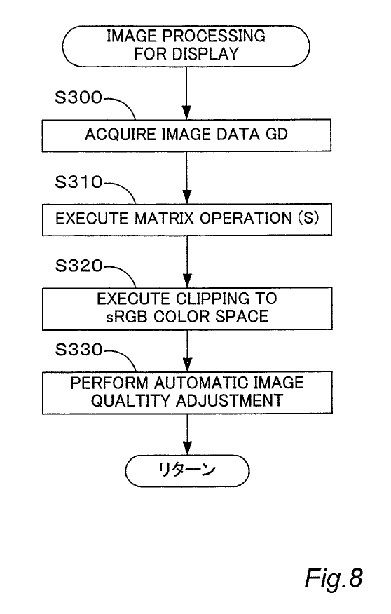

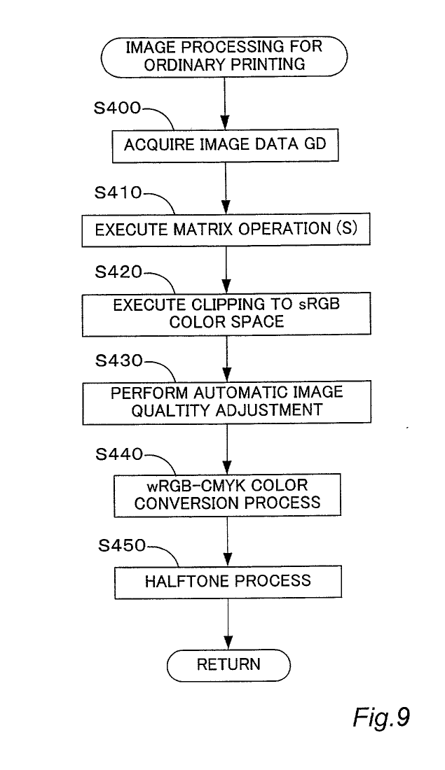

Image processing in a personal computer PC pertaining to this example is described with reference to FIG. 6-FIG. 9. FIG. 6 is a flow chart showing a processing routine for image processing in a personal computer PC pertaining to this example. FIG. 7 is a flow chart showing a processing routine for image processing for printing based on image processing control information in a personal computer PC. FIG. 8 is a flow chart showing a processing routine for image processing for display based on image processing control information in a personal computer PC. FIG. 9 is a flow chart showing a processing routine for image processing for normal printing in a personal computer PC.

An image file GF generated by a digital still camera 12 is provided to personal computer PC via a cable, or, via a memory card MC. When by means of control by a user, an image data processing application (program) installed on HDD 153, namely a retouch application, or, a printer driver, is run, CPU 150 commences reading the image file GF.

Alternatively, by means of detecting insertion of a memory card MC in card slot 153, or, connection of digital still camera 12 to I/O terminal 154 via a cable, CPU 150 may automatically run the application and commence reading the image file GF.

CPU 150, for example, upon reading out the image file GF from memory card MC, temporarily stores the read out image file GF in RAM 151 (Step S100). CPU 150 searches for an image processing control tag in the appended information storage area 112 of the image file GF stored in RAM 151 (Step S110). Where CPU 150 has successfully searched/discovered an image processing control tag (Step S110: Yes) it acquires the image processing control information GC written at the time the image data was generated (Step S120). CPU 150 executes image processing, described in detail hereinbelow, on the basis of the analyzed image processing control information GC (Step S140), outputs (transmits) the image processed image data GD to color printer 20 and monitor 14 (Step S150), and terminates the processing routine. In this example, as shown in FIG. 1, image processing for printing is performed on image data to be output to color printer 20, and wRGB data (CMYK data obtained by conversion from wRGB data) is output. For image data for output to monitor 14, on the other hand, image processing for display is performed, and sRGB data is output. While the data output to color printer 20 is CMYK data, for convenience it is designated wRGB in FIG. 1, in order to describe the difference of the RGB color space used at the time of image processing. The relationship of the sRGB color space and the wRGB color space are described later.

CPU 150, in the event that an image processing tag could not be searched/discovered (Step S120: No), cannot execute image processing reflecting the image processing control information GC at the time of image data creation, and therefore executes ordinary image processing (Step S160), outputs (transmits) the image processed image data GD to color printer 20 and monitor 14 (Step S150), and terminates the processing routine.

Image processing based on image processing control information executed in personal computer PC is described in detail with reference to FIG. 7 and FIG. 8. The personal computer PC in this example executes both image processing for printing and image processing for display on one image data GD. First, image processing for printing is described.

The CPU 150 of personal computer PC fetches the image data GD from the read out image file GF (Step S200). This fetched image data GD is a copy, and until image processing is finished various image processes are performed on the copy image data GD. Digital still camera 12, as noted previously, stores image data as a file of JPEG format, and in a JPEG file image data is stored using a YCbCr color space to increase compression.

CPU 150 executes a 3×3 matrix operation S to convert image data based on the YCbCr color space to image data based on the RGB color space (Step S210). Matrix operation S is the operation equation indicated below.

$$( \begin{matrix}R s \\ G s \\ B s\end{matrix} ) = S ( \begin{matrix}Y \\ C b - 128 \\ C r - 128\end{matrix} )$$

$$S = ( \begin{matrix}1 & 0 & 1.40200 \\ 1 & - 0.34414 & - 0.71414 \\ 1 & 1.77200 & 0\end{matrix} )$$

As a result of matrix S conversion, image data may assume negative values or positive values of 256 or greater (in the case of 8-bit tone). At the time of image processing for printing, these negative values, or, positive values of 256 or greater are kept as-is, and subsequent image processing continues.

CPU 150 executes gamma correction on image data based on the RGB color space obtained in this way (Step S220). During execution of gamma correction, CPU 150 acquires a DSC-side gamma value from the image processing control information GC, and executes gamma conversion processing on video data using the acquired gamma value. That is, a gamma value is also included in the image processing control parameters stipulated by the image processing control information GC. The operation equation for gamma correction is as follows.

$$R s , G s , B s ≧ 0$$

$$R {s}^{′} = {( \frac{R s}{255} )}^{γ} \qquad G {s}^{′} = {( \frac{G s}{255} )}^{γ} \qquad B {s}^{′} = {( \frac{B s}{255} )}^{γ}$$

$$R s , G s , B s < 0$$

$$R {s}^{′} = - {( \frac{- R s}{255} )}^{γ} \qquad G {s}^{′} = - {( \frac{- G s}{255} )}^{γ} \qquad B {s}^{′} = - {( \frac{- B s}{255} )}^{γ}$$

CPU 150 executes on the gamma corrected image data GD a matrix operation (N⁻¹M) that associates the original color space and the wRGB color space (Step S230). The image file GF used in this example can include color space information at the time of image generation, or, color space information to be used at the time of image processing, so where the image file GF includes color space information, CPU 150, when executing matrix operation (N⁻¹M), refers to the color space information, calculates the corresponding matrix N⁻¹M, and executes the matrix operation.

Matrix operation (N⁻¹M) is a composite matrix of matrix operation M, which uses matrix M to convert an RGB color space to an XYZ color space, and the inverse matrix operation N⁻¹ of the matrix operation N, which uses matrix N to convert a wRGB color space to an XYZ color space. Matrix M is a matrix for reflecting image data (color values) not included in the color gamut of the sRGB color space but valid as data, converting image data based on an RGB color space to image data based on an XYZ color space. The matrix values of matrix M are determined in accordance with the color space information. In inverse matrix N of matrix N is a matrix for converting image data converted by matrix operation M into image data based on an XYZ color space into the wRGB color space having a wider definition range than the sRGB color space (restore to RGB color space). The XYZ color space is one of the machine-independent color spaces that are not dependent on machine output characteristics, and is used to perform association of color values in the RGB color space and the wRGB color space. Matrix operation (N⁻¹M) is the operation equation indicated below.

$$( \begin{matrix}R w \\ G w \\ B w\end{matrix} ) = {N}^{- 1} M ( \begin{matrix}R {s}^{′} \\ G {s}^{′} \\ B {s}^{′}\end{matrix} )$$

$${N}^{- 1} M = ( \begin{matrix}0.7152 & 0.2848 & 0.0001 \\ 0.0000 & 1.0001 & 0.0000 \\ 0.0000 & 0.0412 & 0.9588\end{matrix} )$$

The color space of the image data GD obtained after executing matrix operation (N⁻¹M) is the wRGB color space, which has a wider definition range than the sRGB color space. Conventionally, the color space used during image processing in printers or computers was fixed to RGB, so the color space of a digital still camera 12 could not be utilized effectively. In contrast to this, in this example, in the event that color space information is included in an image file GF, a matrix (N⁻¹M) used for matrix operation M is modified in correspondence with the color space information, so the color space of digital still camera 12 can be utilized effectively, to achieve correct color reproduction.

CPU 150 executes inverse gamma correction on image data obtained by means of matrix operation (N⁻¹M) (Step S240). When executing gamma correction, CPU 150 acquires a printer-side default gamma value from HDD 152, and uses the inverse of the acquired gamma value to execute an inverse gamma correction process on the image data GD. The operation equation used for inverse gamma correction is as follows.

$$R {w}^{′} = {( \frac{R w}{255} )}^{1 / γ} \qquad G {w}^{′} = {( \frac{G w}{255} )}^{1 / γ} \qquad B {w}^{′} = {( \frac{B w}{255} )}^{1 / γ}$$

CPU 150 executes automatic adjustment processing of image quality on the inverse gamma corrected image data GD (Step S250). In automatic adjustment processing in this example, image data GD contained in the image file GF is analyzed to acquire characteristic parameters indicating image quality, and automatic adjustment of image quality to correct the image data to reflect image processing control information GC contained in the image file GF and the acquired characteristic parameters is executed. In image quality automatic adjustment processing, standard parameters marked for correction are determined in advance, and the image data is corrected such that the characteristic parameters of the image data are brought into approximation with, or matched with the standard parameters. At this time the image processing control information GC can be used to modify the standard parameter values, or, used for modification to the extent that characteristic parameters are brought into approximation with standard parameter values.

Correction of image data for, for example, brightness, contrast, color balance and the like is typically termed tone curve, performed on individual picture element (pixel) units using a characteristic curve that associates RGB signal input level and output level. For example, for saturation, sharpness, noise reduction and the like, pixel operation processing (filter processing), not tone curve processing, is preformed on pixel units.

CPU 150, once completing picture quality automatic processing, executes wRGB-CMYK color conversion processing to generate data for printing (Step S260). To reflect in the original image data GD the results of image processing of copy image data GD up to this point, overwrite of the image data is selected. In wRGB color conversion processing, CPU 150 refers to a conversion lookup table (LUT) stored in HDD 152 and associating the wRGB color space with the CMYK color space, and converts the color space of the image data from the wRGB color space to the CMYK color space. That is, image data consisting of R/G/B tone values is converted, for example, to 6-color tone of C/M/Y/K/LC/LM, for use by color printer 20.

CPU 150 executes halftone processing (Step S270) and returns to the routine shown in FIG. 6. In halftone processing, the color-converted image data is received, and a tone number conversion process is performed. In this example, after color conversion the image data is represented as data having 256 tone width for each color. In contrast, with the color printer 20 of this example, only a state of either “form dot” or “do not form dot” can be assumed, so the color printer 20 of this example can only represent two tones locally. So, image data having 256 tones is converted to image data represented by two tones representable by the color printer 20. As a representative method for this two-toning (binarization) process, there is a method called the error diffusion method and a method called the systematic dithering method.

In the color printer 20, before color conversion, in the event that the resolution of the image data is lower than the print resolution, linear interpolation is performed to create new data between adjacent image data, and conversely where higher than print resolution, data is thinned out at a given proportion, to perform resolution conversion processing to convert the resolution of the image data to the print resolution. Color printer 20 performs an interlacing process to line up image data converted to a format representing dot formation yes/no into the order in which it will be sent to the color printer 20.

Next, image processing for display executed in personal computer PC is described with reference to FIG. 8. Of the processes executed in each step, processes similar to processes in image processing for printing described with reference to FIG. 7 will be described only briefly. The CPU 150 of personal computer PC fetches the image data GD from the read out image file GF (Step S300). In image processing of image data for display, overwriting or the like is not performed on the original image data GD, rather, image processing is always performed on copy image data. CPU 150 executes a 3×3 matrix operation S to convert image data based on the YCbCr color space to image data based on the RGB color space (Step S310). Matrix operation S is the operation equation described previously. CPU 150 performs clipping in the color gamut of the sRGB color space resulting from matrix operation S (Step S320). Accordingly, in the event that, for example, image data (RGB data) obtained after matrix S conversion included negative values, these are rounded to 0, or where values of 256 or greater were included (in the case of 8-bit data), these are rounded to 255.

CPU 150 executes automatic adjustment processing of image quality on the image data GD based on the sRGB color space, obtained by executing matrix operation S (Step S330), and returns to the routine shown in FIG. 6. In this way, image data GD for display on a CRT or other monitor 14 is not subjected to color space conversion to the wRGB color space; rather the color space of the image data GD is kept at the sRGB color space.

Next, ordinary image processing executed in personal computer PC is described with reference to FIG. 9. Of the processes executed in each step, processes similar to processes in expansion image processing described with reference to FIG. 7 will be described only briefly. The CPU 150 of personal computer PC fetches the image data GD from the read out image file GF (Step S400). CPU 150 executes a 3×3 matrix operation S to convert image data based on the YCbCr color space to image data based on the RGB color space (Step S40). Matrix operation S is the operation equation described previously. CPU 150 performs clipping in the color gamut of the sRGB color space resulting from matrix operation S (Step S420). Accordingly, in the event that, for example, image data (RGB data) obtained after matrix S conversion included negative values, these are rounded to 0, or where values of 256 or greater were included (in the case of 8-bit data), these are rounded to 255.

CPU 31 executes automatic adjustment processing of image quality on the image data based on the sRGB color space, obtained by executing matrix operation S (Step S4330), and executes an sRGB-CMYK color conversion process for printing (Step S440). This processing routine is executed in the event that the color space set at the time of image data creating cannot be acquired from the image file GF, that is, when an image processing control tag cannot be discovered, and employs an ordinary sRGB-CMYK color conversion table. Finally, CPU 31 executes halftone processing (Step S450) and returns to the main routine shown in FIG. 6.

CPU 150, even when executing ordinary image processing, executes image processing separately for image data GD for transmission to the color printer 20, and image data GD for transmission to a CRT or other monitor 14. Image processing for display is executed analogously to processing in image processing based on image processing control information described using FIG. 8, so description thereof is omitted.

As described hereinabove, according to the personal computer PC in this example, image data GD for transmission to a color printer 20 and CRT or other monitor 14 having different color space range output capabilities can be subjected to separately to image processing matched to the color space range output capabilities of each output apparatus 14, 20. Accordingly, the entire range of the color space range representable by each output apparatus 14, 20 can be utilized, and images that maintain color saturation in each output apparatus 14, 20 can be output.

For example, where color printer 20 can reproduce image data GD based on the wRGB color space having a wider defined range that the sRGB color space that is the color space that can be output by monitor 14, if image data GD based on the wRGB color space is output on monitor 14, of the defined range of the wRGB color space, only the range overlapping the defined range of the sRGB color space can be displayed on the monitor 14. As a result, the color saturation of image data GD displayed on monitor 14 will be low, and the colors of the displayed image data GD will be light and dull. In contrast to this, in this example, image data GD for display by monitor 14 is not subjected to color space conversion to the wRGB color space, and the color space of the image data GD can be kept at the sRGB color space, so the colors of the image data GD displayed on monitor 143 can be displayed vividly.

Accordingly, differences in output result by color printer 20 and output result by monitor 14 for the same image data GD can be reduced, and image processing free of unpleasant sensation may be performed. Also, proper image processing can be achieved without acquired through experience differences in output characteristics of the color printer 20 and the monitor 14.

F. Other Examples

In the preceding example, image processing of image data GD for output by color printer 20 and monitor 14 is performed in a personal computer PC, but where the printer 20 is equipped with a small display apparatus, all image processing could be performed by the color printer 20. In this case, image processing of image data GD, display of image processed image data, and printing of image processed image data GD would all be realized by means of color printer 20. Alternatively, all or a portion of the image processing could be performed on a server over a network.

Although the image processing apparatus, image processing method, image processing program and image output apparatus pertaining to the present invention have been described based on an example, the example merely serves to facilitate understanding of the invention, and is not limiting of the invention. It is obvious that equivalent alterations and modifications to the invention are possible without departing from the spirit and scope of the claims, and these equivalents are included in the present invention.

In the preceding example, image processing control information GC includes the parameters of light source, exposure compensation, target color space, brightness and sharpness, but in this example it is an arbitrary decision which parameters will be used as image processing control information GC, as long as at least target color space (the color space at the time of image creation or the objective color space) is included.

The values of matrix S and N⁻¹M in the equations are not limited to the example, and may be modified as appropriate depending on color target space or color space utilizable in color printer 20 or the like.

While the preceding example describes a digital still camera 12 as the image file generating device, scanners, digital video cameras or the like may be used as well. Where a scanner is used, specification of data for inclusion in an image file GF may performed on a computer PC, or performed with the scanner independently by providing the scanner with preset buttons having assigned thereto preset information for setting information, or with a display screen and setting buttons for making optional settings.

While the preceding embodiment describes an Exif format file as a specific exemplary image file GF, the image file format herein is not limited thereto. It is possible to use any image file that includes image data generated by a image data generating apparatus, and image processing control information GC describing conditions at generation (information) of the image data. The use of such files enables image data generated by a image data generating apparatus to have its image quality adjusted automatically for output by an output apparatus.

In the preceding example there was described as an example the case of image data GD and image processing control information GC being included in the same image file GF, but it is not always necessary for image data GD and image processing control information GC to be stored in the same file. That is, it is sufficient for image data GD and image processing control information GC to be associated, for example, creating association data associating image data GD and image processing control information GC, and storing one or a plurality of image data and image processing control information GC in independent files, referring to the associated image processing control information GC when processing the image data GD. In this case, although image data and image processing control information GC are stored in separated files, at the point in time of image processing using image processing control information GC, the image data and image processing control information GC are indivisibly related, so functionality is substantially the same as with storage in a single file. That is, a mode in which associated image data and image processing control information GC are used, at least in the point in time of image processing, is included in the image file GF in this example. Motion video files stored on optical media such as CD-ROM, CD-R, DVD-ROM DVD-RAM and the like are also included.

What is claimed is:

1. An image processing apparatus for performing image processing of image data, said image processing apparatus comprises:
print image data generating means for executing image processing of the image data using image processing control information that is associated with the image data and that controls image processing of the image data, to generate image data for printing; and
display image data generating means for executing image processing of the image data with consideration of the color reproduction characteristics of the display apparatus, which differ from those of the output apparatus that outputs the print image data, to generate image data for display.

2. An image processing apparatus according to claim 1 wherein the image processing control information includes color space information that is information relating to color space at the time of generating image data;
image processing performed by the print image data generating means involves reflecting the color space information and converting the color space of the image data from a first color space to a second color space including within the definition range thereof image data at the time of image data generation and having a definition range wider than that of the first color space; and
image processing performed by the display image data generating means involves image processing in consideration of the image processing control information, and color space conversion, regardless of the color space information, of the color space of the image data from the first color space to a third color space reproducible by the display apparatus.

3. An image processing apparatus according to claim 1 wherein the image processing control information includes color space information that is information relating to the color space to be used at the time of image data processing;
image processing performed by the print image data generating means involves reflecting the color space information and converting the color space of the image data from a first color space to a second color space including within the definition range thereof image data at the time of image data generation and having a definition range wider than that of the first color space; and
image processing performed by the display image data generating means involves image processing in consideration of the image processing control information, and color space conversion, regardless of the color space information, of the color space of the image data from the first color space to a third color space reproducible by the display apparatus.

4. An image processing apparatus according to claim 2 or claim 3 wherein the third color space is an sRGB color space,
the second color space is a wRGB color space having a definition range wider than the sRGB color space, and
the display image data generating means, in the event that the first color space is the sRGB color space, performs color space conversion from the first color space to the third color space.

5. An image processing apparatus according to claim 1 wherein the print image data generating means, in the event the image processing control information cannot be used, performs image processing while preserving the color space of the image data in the first color space, to generate the image data for printing; and
the display image data generating means, in the event that it is determined that the image processing control information is not contained in the image file, performs image processing while preserving the color space of the image data in the first color space, to generate the image data for display.

6. An image processing apparatus according to claim 5 wherein the first color space is an sRGB color space.

7. An image processing apparatus according to any of claims 1 to 6 further comprising:
print image data transmitting means for transmitting the generated image data for printing to a printing apparatus; and
display image data transmitting means for transmitting the generated image data for display to the display apparatus.

8. An image processing method for image data, said image processing method comprising:
performing image processing on the image data using image processing control information that is associated with the image data and that controls image processing of the image data to generate image data for printing; and
performing image processing on the image data with consideration of the color reproduction characteristics of the display apparatus to generate image data for display.

9. An image processing method according to claim 8 wherein in the event that the image processing control information cannot be used, image processing is performed while preserving the color space of the image data in the first color space, to generate the image data for printing; and image processing is performed while preserving the color space of the image data in the first color space, to generate the image data for display.

10. An image processing method according to claim 8 or claim 9 further comprising:
transmitting the generated image data for printing to a printing apparatus; and
transmitting the generated image data for display to the display apparatus.

11. An image processing program for performing image processing on image data, wherein the image processing program realizes by means of a computer:
a function for performing image processing on the image data using image processing control information that is associated with the image data and that controls image processing of the image data to generate image data for printing; and
a function for performing image processing on the image data with consideration of the color reproduction characteristics of the display apparatus to generate image data for display.

12. An image processing program according to claim 11 wherein in the event that the image processing control information cannot be used, image processing is performed while preserving the color space of the image data in the first color space, to generate the image data for printing; and image processing is performed while preserving the color space of the image data in the first color space, to generate the image data for display.

13. An image processing program according to claim 11 or 12 wherein the image processing program further realizes by means of a computer:
a function for transmitting the generated image data for printing to a printing apparatus; and
a function for transmitting the generated image data for display to a display apparatus.
